(19) United States
(12) Patent Application Publication
(10) Pub. No.: US 2001/0054817 A1
(43) Pub. Date: Dec. 27, 2001

(54) Method & device for identifying drinkware

(76) Inventors: Susan Cameron Kelley, La Mesa, CA (US); Janie Brown Kelley, La Mesa, CA (US)

Correspondence Address: CONNORS ASSOCIATES, 1600 DOVE ST, SUITE 220, NEWPORT BEACH, CA, 92660

(21) Appl. No.: 09/885,769

(22) Filed: Jun. 20, 2001

Related U.S. Application Data
(60) Provisional application No. 60/213,007, filed on Jun. 21, 2000.

(51) Int. Cl. B42D 15/00

(52) U.S. Cl. 283/70; 283/81; 283/101

(57) ABSTRACT

There is a problem: At a gathering, individual identical pieces of drinkware of different users are indistinguishable from each other. Consequently, they are misidentified and one person mistakenly picks up the drinkware of someone else. Band devices, each with a unique aspect that distinguishes an individual piece of drinkware, are wrapped around a portion of individual pieces of drinkware. The individual pieces of drinkware so identified with a band device are each unique, and thus the individual pieces of identical drinkware are distinguished.

### RELATED APPLICATIONS

This application is a utility patent application based on U.S. provisional patent application Ser. No. 60/213,007, filed Jun. 21, 2000, entitled Method And Device For Identifying Drinkware, which is incorporated herein by reference and made a part of this application.

### BACKGROUND OF THE INVENTION

Frequently at parties and other social gatherings, people move about and carry with them beverages in drinkware. This drinkware may be, for example, water glasses, wine glasses, mugs, steins, bottles, cans, etc. Often at such a gathering, the individual pieces of drinkware of different users are placed on coffee tables or other locations along side each other. The individual pieces of drinkware are often identical, and cannot be distinguished from one another. And beverages within the individual pieces may be the same color. Consequently, there is a problem: At a gathering, the individual identical pieces of drinkware of different users are frequently indistinguishable from each other. Therefore, they are often misidentified and one person mistakenly imbibes from the drinkware of someone else.

### SUMMARY OF THE INVENTION

This invention provides a simple, convenient, and, in many cases, a low cost solution to this problem (Expensive, up-scale identifying means including precious or costume jewelry also come within the scope of this invention). Namely, band devices, each with a unique aspect that distinguishes an individual piece of drinkware, are wrapped around a portion of individual pieces of drinkware used at a gathering. The individual pieces of drinkware, otherwise indistinguishable from each other, are identified with a unique band device, and thus, the individual pieces of identical drinkware are distinguished from each other.

Moreover, at the same time, the drinkware may be decorated in a fashion that enhances through decoration the festive atmosphere of the party, supports the theme of the party, provides advertisement, or in other ways contributes to the occasion. These bands may also be used as an advertising medium.

According to this invention, a method is provided of identifying drinkware. This method comprises wrapping around a portion of an individual piece of drinkware a band device having a unique aspect that distinguishes the individual piece of drinkware so identified with the band device from other individual pieces of identical drinkware. The unique aspect of the band device may be its shape, its color, its size, or an object, such as a charm or a bead or other sculptural work in the form of a corporate logo, hanging from it, or incorporated within the band device. The band device may or may not be removable, but expensive band devices would be removed and re-used.

This invention also provides novel band devices: a strap-on version and a snap-on version. The strap-on version comes in two forms: The first form comprises a sheet of elastic material, preferably a foam polyurethane, having a length sufficient to wrap around the circumference of a portion of an individual piece of drinkware. This elastic sheet has opposed ends, an inside surface, and an outside surface with a unique aspect capable of distinguishing different individual pieces of identical drinkware. The inside surface has thereon an adhesive that enables the opposed ends to be bonded to each other or to the container to form the sheet into a loop that at least partially wraps around the drinkware. Instead of an adhesive, a hook and pile fastener such as a Velcro® fastener, may be used to attached the opposed ends.

The second form also comprises a sheet of material having a length sufficient to wrap around the circumference of a portion of a n individual piece of drinkware. The sheet need not be elastic, but like the first form, the outside surface of the sheet has a unique aspect capable of distinguishing different individual pieces of identical drinkware. In the second form, the inelastic sheet may be made, for example, of an inexpensive material such as paper or cloth. The opposed ends of the sheet have one component of a two component interlocking fastener. Consequently, the opposed ends are adapted t o be attached to form the sheet into a loop that at least partially wraps around the drinkware. A low cost way to provide such a two-component interlocking fastener is to form a tab at one end that fits into a slit in the other end.

The unique aspect of the outside surface of both these forms may be its shape, its color, or its size. Moreover, the outside surface may be imprinted or otherwise marked with advertisements or band logos. The strap-on band device ranges from about ½ to about 6 inches in width and from about 9 to 13 inches in overall length.

One embodiment of the snap-on version comprises a ring member having an outside diameter of from approximately ⅞ to approximately 2 inches and an inside diameter of from approximately ⅝ to approximately 13/4 inch. This ring member has a narrow slot therein having a width of from approximately 0.03 to approximately 0.5 inch. It is made of a resilient, flexible material that enables the ring member to be attached and detached to a structural portion of an individual piece of drinkware by passing this structural portion through the slot. The ring member flexes to allow the structural portion to pass through the slot and then contracts so that the ring stays attached to the structural portion until removed.

Another embodiment of the snap-on version comprises a ring-type member formed from a flexible, resilient, looped wire defining an open ring with a restricted diameter that allows this device to b e attached to a structural portion of an individual piece of drinkware such as a stem or like drinkware structure. The looped wire carries jewelry elements, for example, pearls, or crystal or glass beads, strung along the looped wire. Spacer elements may be dispersed between the jewelry elements to create different band devices, each with a unique aspect based on the arrangement of jewelry elements and spacer elements. For example, different types and number may be used, including objects displaying advertisements that may be the same o r different. The combinations are infinite. The wire has opposed ends that are unattached to each other and provide an open space through which the structural portion of the drinkware passes to inside the looped wire. Stops at these ends prevent the jewelry elements from sliding off the wire. The stops may, for example, be either jewelry elements or spacer elements. The looped wire has memory and it springs back into its original position but opens to allow passage through the open space of a structural portion of the drinkware to which the band device is attached and detached.

In one configuration of the snap-on version using the looped wire, the ends are spaced apart. In another configuration, the ends overlap. In the configuration with the overlapping ends, these ends are manually moveable away from each other onto a position were these opposed ends are more opened to allow the structural portion of the drinkware to pass there between to inside the looped wire. For example, the user may pull the overlapping ends apart laterally, or twist the looped wire, or simply press the structural portion against the overlapping ends to part these ends and create the open space, forcing the structural portion through the open space and inside the looped wire.

This invention also includes the manner in which the strap-on and snap-on are packaged and sold. A package is provided containing a plurality of band devices, individual band devices within the package being different than at least some of the other band devices in the package. These band devices are capable when attached to an individual piece of drinkware to identify this individual piece of drinkware and distinguish it from other individual pieces of identical drinkware having other different band devices from the same package attached thereto.

This invention also includes a novel method of advertising where the trademarks such as logos of advertisers are attached to the band devices or the band devices themselves have imprinted thereon o r otherwise carry advertisements. The jewelry and spacer elements may be formed of precious metals such as gold and silver and/or of semi-precious stones, plastic, glass, and/or crystal beads, and can be charms with advertiser or corporate names embossed thereon. The jewelry-advertising elements are strung on the looped wire to create the unique aspect of each individual band device.

### DESCRIPTION OF THE DRAWING

The preferred embodiments of this invention, illustrating all its features, will now be discussed in detail. These embodiments depict the novel and non-obvious band devices of this invention for identifying drinkware and methods of their use as shown in the accompanying drawing, which is for illustrative purposes only. This drawing includes the following figures (FIGS.), with like numerals indicating like parts:

FIG. 1 is a perspective view of the first embodiment of the drinkware identifying strap-on band device (first form) of this invention.

FIG. 2 is a perspective view of the strap-on band device shown in FIG. 1 wrapped around a can of beverage.

FIG. 3A is a plan view showing the inside surface of the strap-on band device shown in FIG. 1.

FIG. 3B is a sectional view taken along line 3B-3B of FIG. 3A.

FIG. 4 is a collection of charms symbolic of different festive occasions that may be attached to the drinkware identifying device of this invention.

FIG. 5 perspective view of the second embodiment of the drinkware identifying snap-on band device of this invention showing a pair of different colored snap-on band devices especially adapted to be placed on the stem of a wine glass as shown in FIG. 6A.

FIG. 6A is a perspective view of one of the colored snap-on band devices shown in FIG. 5 placed on the stem of a wine glass.

FIG. 6B is a perspective view of an alternate embodiment of the snap-on band device with interlocking male and female components at the ends of the device.

FIG. 7 is a package containing a plurality of the snap-on band devices shown in FIG. 5, such individual devices being different than at least some of the other devices in the same package.

FIG. 8 is a package containing a plurality of the strap-on band devices shown in FIG. 1, such individual devices being different than at least some of the other devices in the same package.

FIG. 9 is a plan view an alternate embodiment of the drinkware identifying strap-on band device (second form) of this invention.

FIG. 10 is a perspective view of another alternate form of the snap-on band device of this invention simulating a pearl necklace.

FIG. 11A is a perspective view of still another alternate form of the snap-on band device of this invention shown in a closed position and employing jewelry beads and spacers strung on an overlapping loop of wire.

FIG. 11B is a perspective view of the snap-on band device of FIG. 11A shown in an open position FIG. 12 is a plan view of the embodiment shown in FIG. 11A.

### DETAILED DESCRIPTION OF THE PREFERRED EMBODIMENTS

### First Embodiment

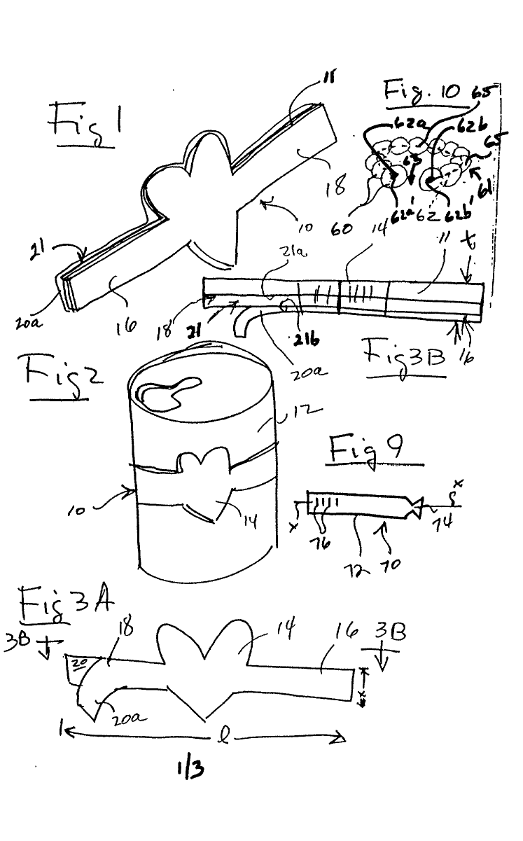

The strap-on version has two forms. The first form is shown in FIGS. 1 through 3A and 3B and the second form is shown in FIG. 9,

### First Form of Strap-on Version

Referring to FIGS. 1 through 3A and 3B, the first form of a strap-on band device 10 is adapted to be wrapped around the exterior of a drink container 12 such as, for example, a beer can.

This band device 10 is made from a sheet 11 of plastic material that is elastic and has a central portion 14 with a unique identifying shape, such as for example, a heart. From this central portion 14 are a pair of opposed and aligned outwardly extending straps 16 and 18. Preferably, the central portion 14 is enlarged relative to the straps 16 and 18. The inside surface 20 (FIG. 3) of the band device 10 is covered with an adhesive coating. Preferably, double sided tape 21 is used to provide the adhesive surface 20. One adhesive side 21a of the tape 21 bears against an inside of the sheet 11 and the other side 21b of the tape is covered with a protective cover 20a that is removed when the device 10 is to be used. The cover 20a is shown in FIGS. 3A and 3B as partially removed. Typically, the band device 10 that is used with 12 ounce cans or bottle has a length I of from approximately 9 to approximately 13 inches and an overall thickness t of approximately 1/30 to approximately ⅛ inch, and its straps 16 and 18 have equal heights x of approximately ½ to approximately 2 inches.

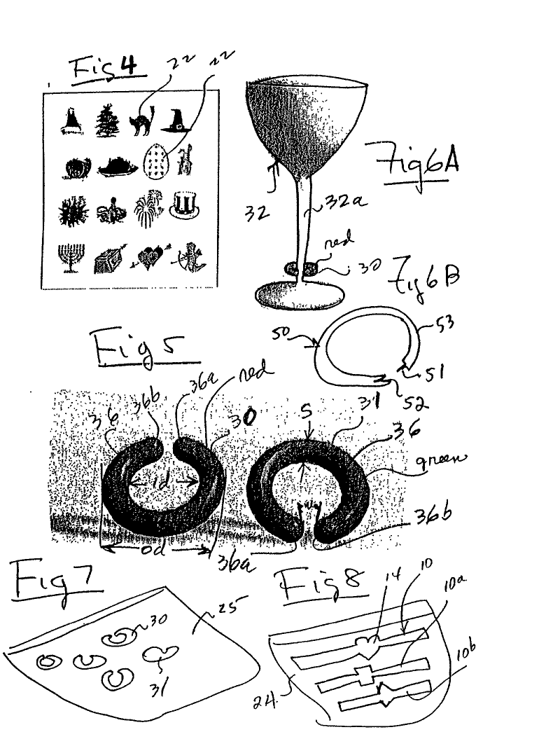

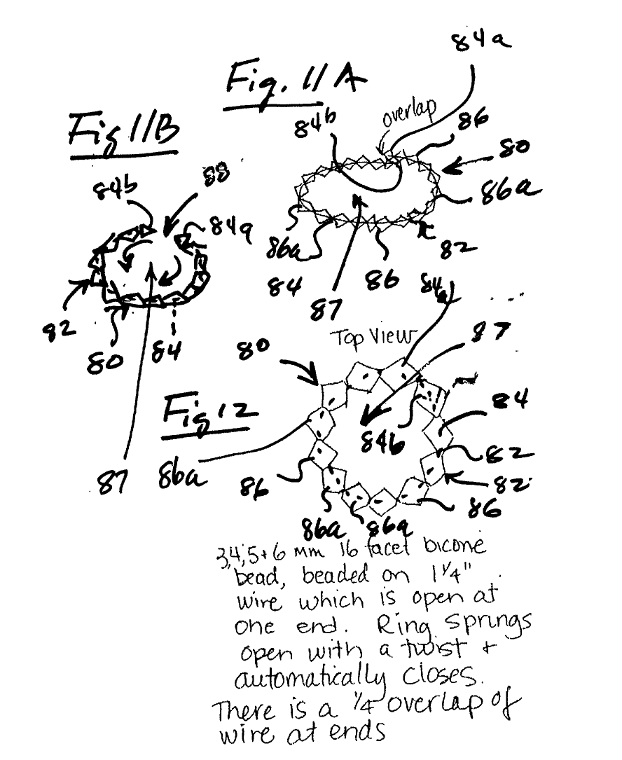

To manufacture the band device 10, the tape 21 is first placed over the surface of a large piece of plastic material from which the devices are to be made. This assembly of double sided tape 21 and plastic material, which has a thickness of from approximately 1/20 to approximately ¼ inch, is then cut like a cookie is cut using a number of dies having different distinguishing shapes. A preferred type of tape 21 may be purchased from Commercial Office Supply of 3M Corporation and the preferred plastic sheet material is, for example, high resiliency (hr) polyurethane foam purchased from Foam Molders & Specialties of Cerritos, Calif. or cross-linked polyethylene/ethylene vinyl acetate. The central portion 14 is cut into a variety of different shapes, for example, a square and diamond i n addition to the heart. Also, charms 22 shown in FIG. 4 may be attached by hooks (not shown) to the band device 10. These charms 22 may depict different holidays or may be the logos of different advertisers and used as promotional items. Alternately, the central portion 14 may be cut into the shape of some or all of the shapes of the charms 22 or imprinted with the logo of an advertiser. As shown in FIG. 8, the band devices 10, 10a, and 10b of different shapes are placed into a package 24, such as, for example, a transparent plastic bag and sold to consumers.

To use the band device 10, the straps 16 and 18 are manually wrapped around the drink container 12 as shown in FIG. 2 and affixed to each other or to the exterior of the drink container. At the occasion where they are to be used, each individual container 12 that is indistinguishable from other like containers would have a differently shaped band device 10 wrapped around it. Consequently, individual users would be able to identify their beverage container from containers of others. The containers 12 could be discarded after the beverage is consumed and the band device not removed or removed and reused.

The band devices 10 are mainly used with six packs of 12 ounce canned drinks or bottled drinks, and conveniently could be sold as part of the six pack where there would be six individual band devices, each with a different uniquely shaped central portion 14. They may also be used on plastic water bottles, drinking glasses, and mugs. In addition to decorating and identifying the drink containers, these band devices 10 also assist the user avoiding getting his or her hands wet when holding a “sweating” or “wet” drink container holding a cold liquid, because the foam sheet 11 acts as an insulator.

Although the band devices 10 are illustrated as having different shapes, they could all have the same shape but be made of different colors.

### Second Form of Strap-on Version

As shown in FIG. 9, the second form of the strap on version, device 70, includes a flexible, plastic sheet 72, preferably made of polyurethane foam, with a tab 74 at one end and a series of parallel slits 76 that are at a right angle to the longitudinal axis x of the sheet. Like the first form of the strap-on version, the sheet 72 has a length sufficient to wrap around the circumference of a portion of an individual piece of drinkware and an outside surface with a unique aspect capable of distinguishing different individual pieces of identical drinkware, for example, the plastic sheet 72 may simply come in a variety of different colors. The opposed ends of the sheet 72 are attached to form the sheet into a loop that wraps around the drinkware by slipping the tab into one of the parallel slits 76.

### Second Embodiment

As shown in FIGS. 5 and 6A and 6B, the second embodiment of this invention is a snap-on band device 30 adapted to be placed around the stem 32a of a wine glass 32, handle (not shown) of a cup, neck (not shown) of a bottle, or other structural portion of a beverage container, typically one is narrow or has a restricted diameter. Two band devices 30 and 31 are shown in FIG. 5. The only difference between them is their color. Band device 30 is red and band device 31 is green. These band devices 30 are made out of resilient, flexible material, for example, polyurethane, or a similar material, using conventional injection molding techniques. They may be round with a smooth o r beveled, etched or grooved surfaces, or with a flat top and bottom or wavy.

Each of the preferred band devices 30 and 31 depicted have an annular or ring shaped body 36, preferably configured like a torus, but with a narrow slot 38 therein to form opposed ends 36a and 36b in the body. The dimensions of the body 36 are critical in order that the band devices 30 and 31 may be snapped onto a vast number of containers. The inside diameter id of the body 36 is from ⅝ to 13/4 inch. The outside diameter od of the body 36 is from ⅞ to 2 inch. The thickness s of the body 36 is from approximately ⅛ to approximately ½ inch. The width w of the slot 38 is from approximately 0.03 to 0.5 inch. Different sizes will be used t o accommodate different sized drink containers. As shown in FIG. 7, the band devices 30 and 31 of different colors are placed into a package 25, such as, for example, a transparent plastic bag and sold t o consumers.

These band devices 30 and 31 are mainly used with wine glasses or mugs, beer steins, or other beverage containers with open handles. The band device 30 is snapped onto the stem 32a, handle, or other structural portion of drinkware by simply pushing the structural portion, for example, the stem 32a, through the slot 38. The body 36 flexes, so that the opposed ends 36a and 36b separate, and then return to an unflexed condition after the structural portion, for example the stem 32a, passes through the slot 38. The plastic comprising the body 36 is flexible and has a memory so the user can either pull the body to separate the ends 36a and 36b, twist the body 35 in order to slip the band device around the stem, handle or neck of the drink container, or push the stem etc. through the slot 38 as discussed above.

Once a band device 30 is placed on a beverage container, one of the charms 22 may be hung on the band device for purposes of advertising, identification, or further decorating the drink container. Instead of using charms 22, the band device may be imprinted with logos or other advertisements. The charms 22 for an occasion party would be, for example: Thanksgiving using turkeys; Christmas using bells, stars, Christmas trees, etc. Also, all the band devices may be identical, and then the charms 22 would serve as the unique identifying aspect used to distinguish and differentiate identical containers.

Personal messages or advertising could be printed on the charms 22 and they would be attached to the body 36 in the same manner using hooks (not shown) as a charm bracelet. The charms 22 and band devices 30 and 31 come in a variety of colors and shapes so the user can identify their own drink container. The band devices 30 and 31 may be used with charms or without. Band devices 30 and 31 in different colors and different numbers may be used on one drink container in a unique color combination for purposes of identification and decoration of the drink container.

The band devices 30 and 31 come in thousands of colors and cross-sectional shapes. The toroidal shape exemplified by the snap-on version illustrated in FIG. 5 is circular in cross-section, but these snap-on band devices may have cross-sectional configurations such as, for example, oval, square, rectangular, star shaped, tree shaped and the like.

As shown in FIG. 6B, an alternate form of the snap-on version, the device 50, is the same as the devices 30 and 31, except that the opposed ends have interlocking components, a male component 5 1 that is inserted into a female component 52. The male component 51 is simply force fitted into the female component 52. The body 53 forming the ring structure is flexible to allow the male component 51 and female component 52 to be brought into engagement.

### Additional Snap-On Embodiments

The various band devices described above may be decorated with beads, sequins, or other type of jewelry glued or otherwise affixed thereto, or strung, to enhance their distinctiveness and appeal. For example, as illustrated in FIG. 10, a band device 61 has costume (or even precious) pearls 60, or other type of beads, strung on a flexible and resilient jewelry wire 62 to form another snap-on version of this invention simulating a pearl necklace. There may dispersed between the pearls 60 individual or groups of spacers 65 to create a unique aspect of the band device 61. There are stops 62a and 62b, which may be jewelry elements or spacer elements, at the opposed ends 62a′ and 62b′ of the wire 62. This snap-on band device 61 is similar to the band devices 30 and 31 shown in FIG. 5 and behaves in a like manner, having ends 62a′ and 62b′ that are spaced apart to provide a gap 63 there between for the stem 32a of the wine glass 32. This enables the band device 61 to be attached and detached to the stem 32a by passing the stem through the slot with the band device 61 flexing to allow the stem to pass through the slot and then contracting so that band device 61 stays attached to the stem until removed.

A further elaboration of the snap-on version shown in FIG. 10 is depicted in FIGS. 11 and 12, namely, a snap-on band device 80 for identifying, for example, the wine glass 32. The band device 80 comprises a ring-type member 82 that snaps onto the stem 32a of the wine glass 32. The ring-type member 82 is formed from a flexible, resilient, looped wire 84 having strung thereon jewelry elements such as, for example, beads 86 with interspersed spacers 86a to create a unique aspect for each individual ring-type member. The wire 84 has opposed ends 84a and 84b that are unattached to each other.

As shown in FIG. 11A, in a first position, these opposed ends 84a and 84b overlap. In a second position, the ends 84a and 84b are opened manually to allow the stem 32a to pass between these parted opposed ends to inside of the looped wire 84. The user may manually move the ends 84a and 84b away from each other onto the second position shown in FIG. 11B by a pulling action, or a twisting action, or a combination of both, so the opposed ends move apart to provide a narrow slot 88, or simply press the stem 32a against the overlapping ends to flex the looped wire 84 and push the stem into the interior 87 of the looped wire. Reversing these procedures enables the ring-type member 82 to be removed from the stem 32a.

In both snap-on band devices 61 and 80, the looped wire defines an open ring with a restricted diameter that allows these devices to be attached to a stem or another structural portion of drinkware. Typically, this restricted diameter is from ⅝ to 13/4 inch, that is, the same as the other snap-on embodiments, the band devices 30 and 31.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A method of identifying drinkware comprising wrapping around a portion of an individual piece of drinkware a band device having a unique aspect that distinguishes said individual piece of drinkware so identified with the band device from other individual pieces of identical drinkware.

2. The method of claim 1 where the unique aspect of the band device is its shape.

3. The method of claim 1 where the unique aspect of the band device is its color.

4. The method of claim 1 where the unique aspect of the band device is its size.

5. A band device for identifying drinkware comprising
a sheet of elastic material having a length sufficient to wrap around the circumference of a portion of an individual piece of drinkware,
said sheet having opposed ends, an inside surface and an outside surface with a unique aspect capable of distinguishing different individual pieces of identical drinkware.
said inside surface having thereon an adhesive that enables the opposed ends to the be bonded to each other or to the container to form the sheet into a loop that at least partially wraps around the drinkware.

6. The band device of claim 5 where the unique aspect of the outside surface is its shape.

7. The band device of claim 5 where the unique aspect of the outside surface is its color.

8. The band device of claim 5 where the unique aspect of the outside surface is its size.

9. A band device for identifying drinkware comprising
a ring member having a narrow slot, and being made of a resilient, flexible material that enables the ring member to be attached and detached to a structural portion of the drinkware by passing said structural portion through the slot with the ring member flexing to allow said structural portion to pass through the slot and then contracting so that the ring member stays attached to said structural portion until removed,
said ring member having a unique aspect capable of distinguishing different individual pieces of identical drinkware.

10. The band device according to claim 9 where the ring member has an inside diameter of from ⅝ to 1¾ inch.

11. The band device according to claim 10 where the ring member has an outside diameter of from ⅞ to 2 inch.

12. The band device according to claim 10 where the ring member has a width of from 0.03 to 0.5 inch

13. A band device for identifying drinkware comprising
a sheet of material having a length sufficient to wrap around the circumference of a portion of an individual piece of drinkware,
said sheet having opposed ends, an inside surface and an outside surface with a unique aspect capable of distinguishing different individual pieces of identical drinkware,
said opposed ends being adapted to be attached to form the sheet into a loop that at least partially wraps around the drinkware.

14. A band device for identifying drinkware comprising
a ring-type member formed from a flexible, resilient, looped wire defining an open ring with a restricted diameter that allows said device to be attached to a structural portion of drinkware,
said looped wire carrying jewelry elements and having opposed ends that are unattached to each other to provide an open space through which a portion of the drinkware passes to inside the looped wire,
said ring-type member having a unique aspect capable of distinguishing different individual pieces of identical drinkware.

15. The band device according to claim 14 where there are stops at the opposed ends to prevent the jewelry elements from sliding off the wire.

16. The band device according to claim 14 where the looped wire has memory and it springs back into an original start position but opens to allow passage through the open space of said portion of the drinkware.

17. The band device according to claim 14 where there is one, or more, spacer elements between at least some jewelry elements.

18. The band device according to claim 14 where the opposed ends are spaced apart.

19. The band device according to claim 14 where the restricted diameter is from ⅝ to 1¾ inch.

20. The band device according to claim 14 where the opposed ends overlap.

21. The band device according to claim 20 where the overlapping opposed ends are manually moveable away from each other onto a position were said opposed ends are opened to allow said portion of the drinkware to pass there between to inside the looped wire.

22. A band device for identifying drinkware having a structural portion, said band device comprising
a ring-type member having opposed ends that are unattached to each other and an inside diameter of from ⅝ to 1¾ inch.
said unattached ends being manually moveable away from each other onto a second position were said opposed ends are opened to allow the structural portion of the drinkware to pass there between to within the ring-type member,
said ring-type member having a unique aspect capable of distinguishing different individual pieces of identical drinkware.

23. A package containing a plurality of band devices, individual band devices being different than at least some of the other band devices, said band devices capable when attached to an individual piece of drinkware identifying said individual piece of drinkware and distinguishing said individual piece of drinkware form other individual pieces of identical drinkware having other different band devices from the same package attached thereto.

24. A method of advertising where the logos of advertisers are attached to band devices or the band devices themselves have imprinted thereon or other wise carry advertisements, and wrapping around a portion of an individual piece of drinkware a band device having a unique aspect that distinguishes said individual piece of drinkware so identified with the band devices from other individual pieces of identical drinkware.
